(19) United States
(12) Patent Application Publication
(10) Pub. No.: US 2013/0226878 A1
(43) Pub. Date: Aug. 29, 2013

(54) SEAMLESS CONTEXT TRANSFERS FOR MOBILE APPLICATIONS

(71) Applicant: NEC Laboratories America, Inc., (US)

(72) Inventors: Jagan Sankaranarayanan, Santa Clara, CA (US); Vahit Hakan Hacigumus, San Jose, CA (US)

(73) Assignee: NEC Laboratories America, Inc., Princeton, NJ (US)

(21) Appl. No.: 13/706,475

(22) Filed: Dec. 6, 2012

Related U.S. Application Data
(60) Provisional application No. 61/603,616, filed on Feb. 27, 2012.

(51) Int. Cl. G06F 17/30

(52) U.S. Cl. CPC G06F 17/30371
USPC 707/689

(57) ABSTRACT

Methods and systems for seamless context transfers include receiving a context object from one or more applications, where the context object including updated context information for a user having an associated timestamp; entering the updated context information into a context information database; determining entries of the context information database for the user having a timestamp older than a predetermined threshold using a processor; purging the determined entries from the context information database; and sending an updated context object to one or more applications that reflects a current state of the context information for the user.

### RELATED APPLICATION INFORMATION

This application claims priority to provisional application Ser. No. 61/603,616, filed on Feb. 27, 2012, incorporated herein by reference.

### BACKGROUND

1. Technical Field

The present invention relates to cloud services and, more particularly, to the transfer of context information between mobile applications.

2. Description of the Related Art

Mobile users exist in an ecosystem of applications, with most applications being distinct from one another. For example, to complete a simple task, such as planning an evening's activities, may involve switching between half a dozen different applications. Each time, the user must provide context information, such as location, timing, and preferences. Completing the transition between applications is frequently the most time-consuming process of completing a task due to the manual data entry required.

While some applications can share context data, at present such applications have predefined sharing relationships with other applications. There is no way for current applications to share arbitrary context data with arbitrary other applications.

### SUMMARY

A method for seamless context transfers is shown that includes receiving a context object from one or more applications, said context object including updated context information for a user having an associated timestamp; entering the updated context information into a context information database; determining entries of the context information database for the user having a timestamp older than a predetermined threshold using a processor; purging said determined entries from the context information database; and sending an updated context object to one or more applications that reflects a current state of the context information for the user.

A system for seamless context transfer is shown that includes a receiver configured to receive a context object from one or more applications, said context object including updated context information for a user having an associated timestamp; a processor configured to enter the updated context information into a context information database, to determine entries of the context information database for the user having a timestamp older than a predefined threshold using a processor, and to purge said determined entries from the context information database; and a transmitter configured to send an updated context object to one or more applications that reflects a current state of the context information for the user.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is an exemplary state diagram illustrating the steps a user may go through to accomplish a task, with context dependencies shown.

FIG. 2 is a diagram of a context transfer service according to the present principles.

FIG. 3 is a block/flow diagram of a method for collecting updated context information according to the present principles.

FIG. 4 is a block/flow diagram of a method for sending updated context information to applications according to the present principles.

FIG. 5 is a diagram of a context transfer system according to the present principles.

### DETAILED DESCRIPTION OF PREFERRED EMBODIMENTS

A mobile user is a consumer of a variety of apps (i.e., services) and the expectation is that these services interact with one another in a seamless manner. The ultimate goal of mobility is to provide mobile users with a seamless experience. The present principles provide a sharing platform that arbitrary applications may access to provide context updates for a mobile user and to access current context information when needed.

Seamless mobility is experienced by a user when apps lose their individual nature and come together in the common purpose of helping the mobile users navigate the world around them in an effective manner. This means that individual apps and mobile services should interact with the mobile user as if they exist in an ecosystem whose collective objective is to ensure that the mobile user can interact with the digital world in a seamless fashion.

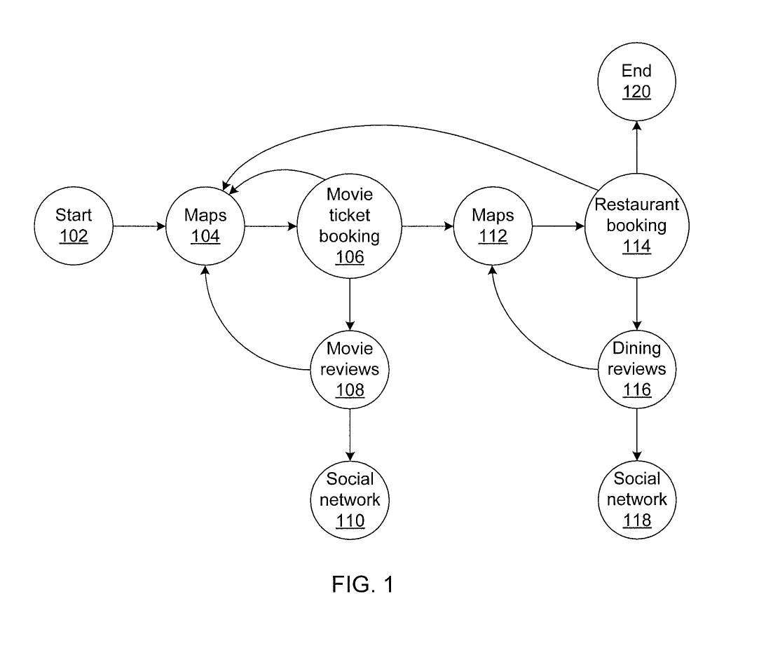

Referring now to FIG. 1, a state diagram is shown that illustrates an exemplary task of planning an evening outing that includes dining at a restaurant and watching a movie. As more and more services are available as apps, mobile users on the go increasingly perform tasks which may involve one or more steps involving one or more apps. The state begins at 102 without any context generated. To achieve the task of planning the evening, the mobile user may invoke a maps app at 104 to first choose an appropriate movie theater. The user then invokes a movie app at 106, identifying the the movie theater chosen at 104 to see the selection of movies playing at the theater. Before selecting a movie that is currently playing in the theater, the user may want to read the reviews on the movie from a movie review app at 108, requiring the user to manually identify specific movies. Furthermore, the user may also want to check a social networking app at 110 to check if any friends liked the movie, or even may want to solicit opinions on the movie choice before booking the tickets, requiring further identification of the movies. Note that the user may have to go back to the map app 104 to change the choice of the movie theater if the reviews at 108 made the user dislike the movie choice.

Once the user is satisfied with the choice of the movie theater and the movie to watch, the user now starts looking for a restaurant to dine. The process of selecting a restaurant involves a similar iterative process involving several apps, including locating nearby applications using a map application at 112. The user would invoke a restaurant booking app at 114 to select a restaurant that is near to the movie theater. Next, the user may want to look at the menu before selecting a restaurant, or check on the reviews, or look up for more recommendations with a restaurant review app at 116. As above, further reference to a social networking app at 118 may be helpful, and the process may need to be done a few times depending on reservations availability before finally settling on a restaurant. The task then completes at 120.

As can be seen from this example, even the simple task of choosing a restaurant and movie may lead a mobile user to navigate through multiple apps. It is worthwhile to note that the most time consuming process in completing the task is frequently the transitions between applications. In other words, when a user moves between one app and the next, the user has to manually provide all of the relevant context information to the second application, without which the second application would not have provided the mobile user with useful answers.

The transition between one app to another while completing a task is called context transfer. The main drawback of the above scenario is that context transfers are slow and subsequent applications have a “cold” context. The user has to bring each application from a cold context to a warm state where the application is aware of the relevant context before being able to produce useful answers. The present principles therefore provide a seamless mobile context transfer service in a cloud system that aids an app platform by providing seamless context transfers, making task completion on mobile devices easier for the user.

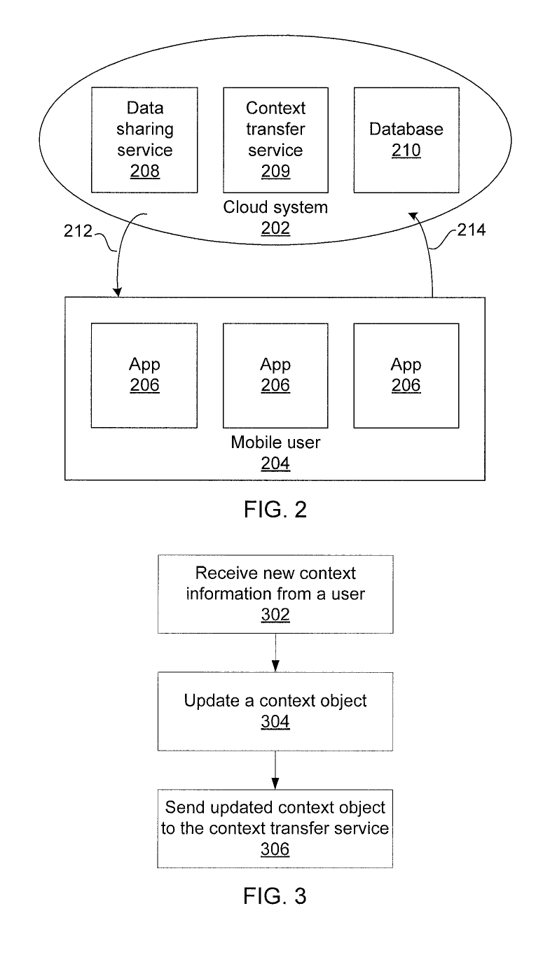

Referring now to FIG. 2, an exemplary context sharing system is shown. A cloud system 202 is in communication with one or more mobile users 204. The mobile user 204 may represent a single mobile device, a set of devices belonging to a user, or even just a set of decentralized user applications that may be accessed anywhere. The mobile user 204 has access to a set of applications 206, each of which performs one or more functions according to information provided to it. For example, each of the functions described above in FIG. 1 may be represented as one or more applications 206.

The cloud system 202 includes a sharing service 208 and a database 210. The database 210 includes information pertaining to the applications 206, and the applications 206 access said database 210 using any appropriate means including, e.g., the internet and wireless networks. Each application 206 is referred to as a “tenant” of the database 210, and the database 210 itself may be a single device or may represent a set of networked devices. The sharing service 208 allows data sharing between tenants of the database 210. It should be recognized that, although the system 202 is described as being a cloud system, the present principles would also apply to an alternative system that had, e.g., only a single device housing the database and sharing service. According to the present principles, the applications 206 receive context objects 212 from the sharing service 208 and provide updated context objects 214 to the sharing service in response to demands from and information provided by mobile user 204.

The context objects 212 and 214 may include any sort of information pertinent to a user's session. For example, the context objects 212 and 214 may include social information that has to do with identity, friends, family, and acquaintances, setting information that describes a user's preferences, role information that describes the roles the user plays, history information that describes previous actions taken by the user, temporal information that describes timing relating to the user's actions, and location information that describes a geophysical or relative location of the user's activities. This list is not intended to be exhaustive, and those having ordinary skill in the art will recognize that any information relating to a user's session may be included. The context object may further include pointers to database entries that have additional information. This may be done to ensure that the size of the context object does not become too large and ensures the freshness of some of the information (e.g., location) in the context objects.

The cloud system 202 may be a Platform as a Service (Paas) that hosts the backend databases 210 of mobile apps 206. The apps 206 may be viewed as frontends that query the database 210 hosted in the cloud 202. The PaaS operator manages the backend databases and resorts to multitenancy to ensure that the operating costs are down and there is sufficient utilization of the computing resources. The quality of service (QoS) on the queries made on the databases is ensured by a Service Level Agreement (SLA) between the tenants (i.e., apps 206) and the provider. The goal of the PaaS provider is to ensure that sufficient resources are available to each of the tenant's queries so that the SLAs are satisfied, while keeping the costs as low as possible. In a mobile cloud 202, the PaaS provider provides several services to enable apps 206 succeed in competitive markets. For example, the provider can enable data sharing between the tenants which would enable the tenants share data with one another by defining sharing arrangements. Next, the provider can provide data integration support to all the tenants so that there is a uniform identity of the users across all the apps 206 hosted in the cloud 202. Next, the provider also provides a data sharing service 208 and context transfer service 209 to aid seamless context transfers between apps that would result in rich mobility for the user. Of course it is not necessary that the provider is directly involved in running of these services but can also play a passive role in enabling tenants from providing useful services to other tenants.

Even though there is a rich variety of apps 206 on mobile devices, they generally do not talk to one another let alone share information to create a seamless mobile experience. The communication between apps is adhoc in the sense that there is no real support to enable them. Some sharing takes place through special application programming interfaces (APIs). The problem with this setup is that it is unidirectional and not scalable in the sense that every app 206 needs to implement the API individually. In general, APIs are expensive to create and maintain, and furthermore may not be expressive enough for most sharing needs between apps 206. Moreover, as apps are often hosted in the same cloud infrastructure 202, there are other less expensive ways of enabling communications between apps 206 hosted in the cloud 202. Thus, the sharing service 208 provided herein facilitates large-scale sharing between mobile apps 206 hosted in a cloud 202.

In addition to providing mobile users 204 with a superior mobile experience, the present principles provide mobile application developers with tools that allow them to easily write rich apps that interact well with other apps in the cloud ecosystem. The context transfer service 209 makes the task of the mobile app developer easier in the sense that the appropriate context information that is both fresh and pertinent to the app 206 is always available. Now, as the user transitions from a first app 206 to a second app 206, it is the first app's responsibility to ensure that the updates to the user's context are appropriately conveyed to the mobile context service 209 with updated context objects 214. The changes to the user's mobile context are subsequently reflected on the context provided to the second app in context objects 212.

In some sense the apps 206 will use this service 209 to ensure that the context is seamlessly handed off to the subsequently invoked app 206 via the transfer service 209, which is much more efficient than either the one-to-one communication or an API. In some sense, as the user 204 is completing a task, the app 206 is the custodian of some part of the context information for the duration a mobile user 204 uses the app 206. The app modifies the user's context and returns the updated context information back to the service as the user transitions to another app 206. If an app 206 does a poor job of providing the subsequent app 206 with the appropriate context, the user would notice that any transition involving a particular app 206 is not quite smooth and may replace the app 206 with an equivalent one from the mobile cloud 202. Finally, it is not necessary that the apps return the updated context only as the user is transitioning from the app 206 but may also periodically return the context to the transfer service 209.

The transfer service 209 is either provided by the provider or any tenant by entering into sharing arrangements with all the apps 206 in the mobile cloud 202. All apps 206 in the mobile cloud 202 can access the context transfer service via a continuous query, which is registered with the mobile context transfer service 209 or via a sharing arrangement with the context transfer service 209. The schema of the context transfer service 209 is evolutionary in the sense that the apps 206 can mutually and collaboratively agree on how to extend it. The context transfer service 209 records all facets of a mobile user 204. For example, the context service includes the personal details, social connections, location, and other details about the user, which are maintained at a reasonable level of freshness.

Each app 206 registers a query to the context transfer service 209 containing the attributes the app 206 is interested in receiving at the invocation of the app 206. In other words, as the app 206 is invoked it receives information to make sense of the context. When the user 204 switches applications 206, the application 206 updates the context information via the mobile context service 209 by sending an updated context object 214.

The updated context objects 214 sent by the apps 206 are inserts in the sense that a new tuple is created with the current time stamp. In other words, the mobile context has a historical log of mobile users 204 for historical data mining. The mobile apps 206 can access the mobile context via, for example, an SQL interface or may enter into sharing arrangements with the users 204 to share part or whole of the mobile context. Sharing the whole of the mobile context may be suitable for services that perform historical analysis on the mobile context and produce useful information, which they further share with the apps 206. For example, there may be a service that takes the mobile context and maintains a vector of user preferences that is always available with a staleness of a few hours.

In most cases, the context object 212 is underspecified in terms of how much data is available. For example, consider the context transfer from a movie application to a social networking application. The user 204 may want to see if any friends liked a particular movie. In this case, the social networking app would like to have more information about the movie such as the title of the movie and the cast of the movie to find relevant information for the user. In some sense, the context object 212 should also contain pointers to where the social networking application can get more information about some of the fields being passed in to the application. A context transfer service 209 coupled with a data sharing service 208 can lead to connections between apps 206 that typically do not interact with one another. The social networking app can, for example, have a handler for when a user looks for a movie and invokes a social networking website, in which case the social networking website can organize its content based on what their friends thought about the movie, news about the movie cast or other information.

The schema of the mobile context evolves in a mutual consensus manner in the sense that the PaaS applies agreed upon improvements to the mobile context, and it is the responsibility of the community of app developers to discuss the merits of one change versus another. Collaborative schema evolution ensures that apps 106 are able to receive useful context information when first invoked as well as able to apply the changes to the context as the mobile user switches to a different app. If the app does not play well with other apps in terms of how the changes to the mobile context is expressed the context switches from other apps to this app would not be quite seamless. Note that the role of the PaaS here is a passive one in that the provider merely ensures that inconsistencies in the scheme of the context switch is identified and resolved amicably in time.

There are several ways of implementing the mobile context transfer service 209 in the cloud 202. One way of implementing the mobile context transfer service 209 is with the active involvement of the PaaS provider. The mobile transfer 209 could be viewed as a service that is maintained by the PaaS provider to ensure that every app 206 receives the appropriate mobile context at the start of its invocation as well as reconciles the updates made to the object 214 by the app 206. Another way is that other tenants in the cloud 202 may provide the service to all the other apps 206. The drawback of both these approaches is that they are centralized, which means that there could be several points of failures.

A more decentralized approach to creating a context transfer service 209 is that each app 206 could separately implement components that deal with sharing integrity in the cloud 202, a marketplace for data sharing and dissemination, physical design problems, mobile access patterns, cloud optimization, identifying QoS service issues and remedial actions, and interoperability. These functions can be implemented using, for example, standard libraries across the apps 206.

Referring now to FIG. 3, a method for sharing context information with a context transfer service 209 is shown. The app 206 receives new context information, either manually entered by the user 204 or through a sensor in a user's device, at block 302. The app 206 uses this information to perform its own processing and also updates a context object 214 at block 304. At block 306, the app 206 sends the updated context object 214 to the context transfer service 209 so that the user 204 can benefit from seamless sharing of collected contextual information.

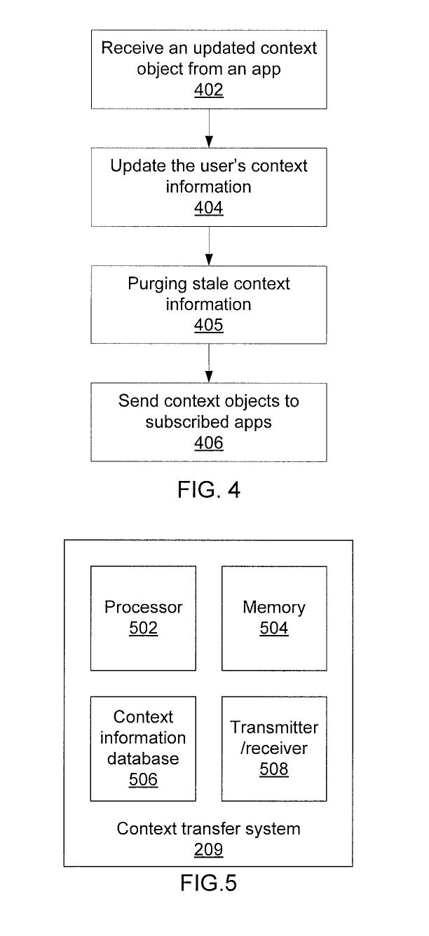

Referring now to FIG. 4, a method for receiving and distributing updated context information is shown. The context transfer service 209 receives an updated context object 214 from one or more applications 206 at block 402. The context transfer service 209 uses the updated context object 214 to update the user's shared context information at block 404 and makes that context information available to subscribed apps 206 by sending new context objects 212 at block 406. Block 406 may send context objects 212 upon a demand from an application 206, or it may send updates periodically or according to a schedule. In a further embodiment, block 406 may “push” context objects 212 to applications 206 as soon as it updates its context information.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Referring now to FIG. 5, an exemplary context transfer system 209 is shown. The context transfer system 209 includes a processor 502 and a memory 504 configured to operate a context information database 506. As described above, the context information database 506 keeps an updated record of a user's context and is regularly purged according to freshness of the context information. For example, if a given piece of context information reaches a threshold age, it may be purged as it is unlikely to be relevant to future tasks. The time limit for freshness may depend on the type of information. For example, a user's present location may be a short-lived piece of information, while a search for information regarding a particular movie might endure until the movie's showtime has passed. The context transfer system 209 further includes a transmitter/receiver 508 that allows the context transfer system 209 to communicate with applications 206 for the purpose of sending and receiving context objects.

Having described preferred embodiments of a system and method for seamless context transfers for mobile applications (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for seamless context transfers, comprising:
receiving a context object from one or more applications, said context object including updated context information for a user having an associated timestamp;
entering the updated context information into a context information database;
determining entries of the context information database for the user having a timestamp older than a predetermined threshold using a processor;
purging said determined entries from the context information database; and
sending an updated context object to one or more applications that reflects a current state of the context information for the user.

2. The method of claim 1, wherein the predetermined threshold is based on a particular kind of context information that a determined entry belongs to.

3. The method of claim 1, further comprising receiving a request for an updated context application from one or more applications, wherein sending the updated context object is responsive to said request receipt.

4. The method of claim 1, wherein updated context objects are sent according to a predefined schedule.

5. The method of claim 1, wherein updated context objects are sent immediately upon entering updated context information into or purging entries from the context information database.

6. A system for seamless context transfer, comprising:
a receiver configured to receive a context object from one or more applications, said context object including updated context information for a user having an associated timestamp;
a processor configured to enter the updated context information into a context information database, to determine entries of the context information database for the user having a timestamp older than a predefined threshold using a processor, and to purge said determined entries from the context information database; and
a transmitter configured to send an updated context object to one or more applications that reflects a current state of the context information for the user.

7. The system of claim 6, wherein the predetermined threshold is based on a particular kind of context information that a determined entry belongs to.

8. The system of claim 6, wherein the receiver is further configured to receive a request for an updated context application from one or more applications and wherein the transmitter is configured to send the updated context object responsive to said request receipt.

9. The system of claim 6, wherein updated context objects are sent according to a predefined schedule.

10. The system of claim 6, wherein updated context objects are sent immediately upon entering updated context information into or purging entries from the context information database.
